(19) United States
(12) Patent Application Publication
(10) Pub. No.: US 2025/0199702 A1
(43) Pub. Date: Jun. 19, 2025

(54) FLEXIBLE SIZED SUPER BLOCK FOR OPTIMIZED PERFORMANCE AND ENDURANCE

(71) Applicant: WESTERN DIGITAL TECHNOLOGIES, INC., San Jose, CA (US)

(72) Inventors: Dhanunjaya Rao Gorrle, Fremont, CA (US); Leeladhar Agarwal, Fremont, CA (US); Arvind Bhushan, San Jose, CA (US)

(73) Assignee: WESTERN DIGITAL TECHNOLOGIES, INC., San Jose, CA (US)

(21) Appl. No.: 18/541,811

(22) Filed: Dec. 15, 2023

(51) Int. Cl. G06F 3/06

(52) U.S. Cl. CPC G06F 3/064; G06F 3/0604; G06F 3/0679

(57) ABSTRACT

A storage device may reduce increases to a program erase cycle count associated with a physical block by forming super blocks of varying sizes. A memory device on the storage device includes one or more dies, each of which is divided into physical blocks. A controller may identify characteristics of data to be stored on the memory device. The controller may then select physical blocks from the one or more dies to be used in forming a super block and optimize the super block configuration based on data characteristics. In forming the super block with one or more physical blocks, the controller may align the super block size with the data characteristics. By aligning the super block size with the data characteristics, data relocation on the super block may be reduced and increases to the program erase cycle count associated with a physical block may be reduced.

### BACKGROUND

A storage device may be communicatively coupled to a host and to non-volatile memory including, for example, a NAND flash memory device on which the storage device may store data received from the host. The memory may be divided into physical blocks and data may be stored in the blocks in various formats, with the formats being defined by the number of bits that may be stored per memory cell. For example, a single-layer cell (SLC) format may write one bit of information per memory cell, a multi-layer cell (MLC) format may write two bits of information per memory cell, a triple-layer cell (TLC) format may write three bits of information per memory cell, and a quadruple-layer cell (QLC) format may write four bits of information per memory cell, and so on.

When data is erased from the memory device, the entire block of data is erased. The lifespan of the memory device may be limited by the number of program/erase cycles (P/E cycles) carried out on the memory device. A PE cycle is a sequence of events in which data is written to a block and is subsequently erased and rewritten. For an SLC block the PE cycle limit may be between 60,000 to 100,000, the program erase cycle limit for a TLC block may be approximately 3000, and the program erase cycle limit for a QLC block may be approximately 1500.

Physical blocks in the memory device may be grouped together into a plane, and a die may include a single plane full of data blocks or multiple planes that have been linked together. The number and configurations of planes within a die may be adaptable. Physical blocks from multiple dies may also be configured to form a super block. i.e., a logical block which may be composed of physical blocks from all the dies and channels in order to extract higher throughput for parallel reads and writes. As the superblock includes a block from each die/channel in the memory device, the size of the superblock is fixed. As technology improves and the number of dies in the memory device increases, the fixed superblock size also increases.

When a workflow being carried out on the storage device does not suit the superblock configuration, a controller on the storage device may perform unnecessary data relocations to manage the data on the memory device. Relocating data from one block to another block may affect the overall write amplification factor of the storage device and the performance in certain applications. Relocating data from a block also causes the controller to use a program erase cycle count, which may end up reducing the lifespan of the storage device and the memory device.

### SUMMARY

In some implementations, the storage device may reduce increases to a program erase cycle count associated with a physical block by forming super blocks of varying sizes. The storage device includes a memory device including one or more dies, each of which is divided into physical blocks. A controller on the storage device identifies characteristics of data to be stored on the memory device. The controller selects physical blocks from the one or more dies to be used in forming a super block. The controller optimizes the super block configuration based on the data characteristics and aligns the super block size with the data characteristics. The controller then forms the super block with one or more physical block, wherein by aligning the super block size with the data characteristics, data relocation on the super block is reduced and increases to the program erase cycle count associated with a physical block is reduced.

In some implementations, a method is provided for reducing increases to a program erase cycle count associated with a physical block by forming super blocks of varying size in a storage device. The method includes identifying characteristics of data to be stored on the memory device and selecting physical blocks from the one or more dies to be used in forming a super block. The method also includes optimizing the super block configuration based on data characteristics and aligning the super block size with the data characteristics. The method further includes forming the super block with one or more physical blocks. By aligning the super block size with the data characteristics, data relocation on the super block is reduced and increases to the program erase cycle count associated with a physical block is reduced.

In some implementations, a method is provided for reducing increases to a program erase cycle count associated with a physical block by forming super blocks of varying size in a storage device. The method includes identifying characteristics of data to be stored on the memory device and selecting physical blocks from the one or more dies to be used in forming a super block. The method also includes optimizing the super block configuration based on data characteristics and aligning the super block size with the data characteristics. The method further includes forming the super block with multiple physical blocks to account for die parallelism for higher performance data. By aligning the super block size with the data characteristics, data relocation on the super block is reduced and increases to the program erase cycle count associated with a physical block is reduced.

### BRIEF DESCRIPTION OF THE SEVERAL VIEWS OF THE DRAWINGS

FIG. 1 is a schematic block diagram of an example system in accordance with some implementations.

FIG. 2 is a block diagram showing fixed sized super blocks and flexible sized super blocks formed in accordance with some implementations.

FIG. 3 is an example flow diagram for forming varying sized super block based on data characteristics information received from a host in accordance with some implementations.

FIG. 4 is an example flow diagram for forming varying sized super block based on data characteristics information determined by the controller in accordance with some implementations.

FIG. 5 is a diagram of an example environment in which systems and/or methods described herein are implemented.

FIG. 6 is a diagram of example components of the host of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

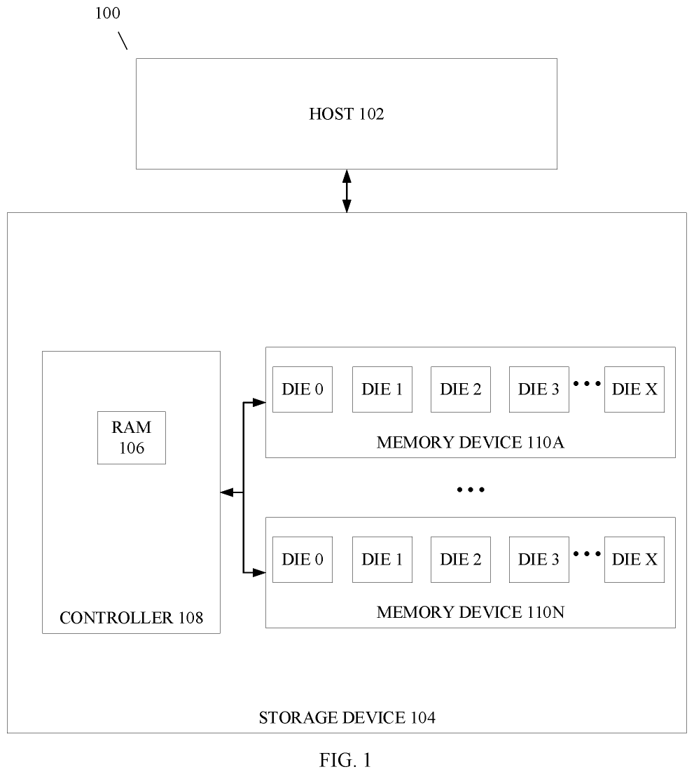

FIG. 1 is a schematic block diagram of an example system in accordance with some implementations. System 100 includes a host 102 and a storage device 104. Host 102 and storage device 104 may be in the same physical location as components on a single computing device or on different computing devices that are communicatively coupled. Storage device 104, in various embodiments, may be disposed in one or more different locations relative to the host 102. System 100 may include additional components (not shown in this figure for the sake of simplicity).

Storage device 104 may include a random-access memory (RAM) 106, a controller 108, and one or more non-volatile memory devices 110a-110n (referred to herein as the memory device(s) 110). Storage device 104 may be, for example, a solid-state drive (SSD), and the like. RAM 106 may be temporary storage such as a dynamic RAM (DRAM) that may be used to cache information in storage device 104.

Controller 108 may interface with host 102 and process foreground operations including instructions transmitted from host 102. For example, controller 108 may read data from and/or write to memory device 110 based on instructions received from host 102. Controller 108 may further execute background operations to manage resources on memory device 110. For example, controller 108 may monitor memory device 110 and may execute garbage collection and other relocation functions per internal relocation algorithms to refresh and/or relocate the data on memory device 110

Memory device 110 may be flash based. For example, memory device 110 may be a NAND flash memory that may be used for storing host and control data over the operational life of memory device 110. Memory device 110 may be included in storage device 104 or may be otherwise communicatively coupled to storage device 104. Memory device 110 may include multiple dies (shown as Die 0-Die X) which may be divided into blocks. Data may be stored in the blocks in various formats, with the formats being defined by the number of bits that may be stored per memory cell. For example, a single-layer cell (SLC) format may write one bit of information per memory cell, a multi-layer cell (MLC) format may write two bits of information per memory cell, a triple-layer cell (TLC) format may write three bits of information per memory cell, and a quadruple-layer cell (QLC) format may write four bits of information per memory cell, and so on. The blocks in memory device 110 may be hybrid blocks, wherein the blocks may be programmed in multiple formats. For example, a block may be initially programmed as an SLC block and later programmed as a TLC block. Formats storing fewer bits in each cell are more easily accessed, durable, and less error-prone than formats storing more bits per cell. However, formats storing fewer bits in each cell are also more expensive.

To reduce background relocation on memory device 110 and limit the number of program erase cycles (PE) cycle used for background relocation, controller 108 may form a super block in an interleaved manner, wherein the super block is a logical block that may include a physical block from one or more dies on memory device 110. The super block size may vary according to the number of physical blocks from one or more dies used to form the super block. The size and configuration of a super block may be determined by controller 108 based on the characteristics of the data to be stored on the super block.

In some implementations, controller 108 may obtain the data characteristics from information provided by host 102 to storage device 104. Host 102 may provide the data characteristics information to storage device 104 through various standard protocols including, for example, Non-Volatile Memory Express (NVMe). In some instances, the data characteristics information may be propagated by host 102 through a vendor-unique command. In some instances, the data characteristics information may be propagated by host 102 through an existing protocol using unused or reserved fields. Prior to transmitting data to storage device 104, host 102 may categorize the data according to the mode of use of the data. For example, host 102 may categorize the data being transmitted to storage device 104 as being used for performance-intensive operations or data storage operations.

Host 102 may specify in, for example, an NVMe command, to storage device 104 the mode of use of the data being transmitted to storage device 104. For example, the NVMe command may include an indication that the data is for performance-intensive operations or data storage operations. Host 102 may also provide an overall data size for data having the same characteristics. When controller 108 is forming a superblock, controller 108 may use the data characteristics to optimize the super block configuration. For example, controller 108 may use the data characteristics to determine the number and types of blocks to include in the super block that is formed to store a certain type of data being received from host 102.

In cases where host 102 follows a standard protocol and does not provide data characteristic information to storage device 104, controller 108 may use the standard commands from host 102 to optimize the super block configuration and determine the optimal number and types of blocks to include in a super block formed to store the data being received from host 102. For example, controller 108 may use the namespace ID in a multi-namespace environment and the formatted sector size for each namespace in configuring a super block. In an example, where storage device 104 is a single function non-volatile device (SFND) that supports multiple namespace, controller 108 may configure the super block for one or more namespaces with the same logical block address formatting. In another example where storage device 104 is a multi-physical functional non-volatile memory device (MFND), storage device 104 may include multiple sub-controllers (also referred to herein as child-controllers), each with its unique controller ID. Data from various sub-controllers may be interleaved and written into the super block. Controller 108 may use the controller IDs in determining the optimal number and types of blocks to include in the super block. When controller 108 configures a super block based on the controller IDs, controller 108 may use the controller IDs to avoid mixing data from different sub-controllers.

Controller 108 may make additional interdependent decisions on, for example, supporting redundant array of independent disks (RAID) parity, reverse lookup data (physical address to host logical block address), and corresponding data location in the super block based on the dynamic configuration of the super block which may be designed by considering all other characteristics of an underlying NAND technology. When the super block is being configured, controller 108 may combine physical blocks with similar bit error rate (BER) and/or program-erase-cycle. Controller 108 may configure the size of each super block in a way to limit the PE cycle count on the physical blocks in the super block and prolong the life of the memory device 110 and storage device 104.

Controller 108 may store super block configuration information with other control data in a non-volatile memory to ensure that the super block configuration information persists across power cycles. The super block configuration information may be a few bytes of additional information associated with each super block that may identify, for example, the number and types of physical blocks associated with the super block.

Consider an example where host 102 is storing a game on storage device 104. The installation data for the game is typically cold in nature in that once the installation data is stored it may be written once and read multiple times. Controller 108 may thus save the installation data in a super block to enforce physical continuity of the game content data on memory device 110. When transmitting the installation to storage device 104, host 102 may provide data information to storage device 104 indicating that the installation data is cold data. If host 102 does not provide the data information to storage device 104, controller may determine the data characteristics from, for example, the logical block address range or other means. In storing the installation data, controller 108 may avoid mixing the installation data with different data sent by host 102, data generated by an operating system, or playing data for another game.

Controller 108 may route the installation data to be stored in a TLC super block for better write amplification. The data sizes for different game installation data may vary and the data may possibly have discrete or sequential logical block address ranges. In some implementations, game installation data may be in one or more streams, each of which may have a stream ID. When host 102 issues an NVMe stream directive command, the command may indicate the installation data size along with the streams which would be written as part of the game download. The first command for a streams may include the number of logical blocks and other critical information such as the stream ID.

Controller 108 may allocate a super block per stream ID, i.e., allocate an open super-block to a stream to avoid mixing the data from a first stream with the data from another stream or with non-stream data. By configuring super blocks to have varying sizes, controller 108 may effectively use the super block's storage capacity. For instance, controller 108 may create a super block that may be filled with data from one or more streams, without needing to pad the super block with predefined data or zero data to close the super block as may be the case where a stream data size is less than that of super block. By forming the super block to correspond with the size of the data being stored, controller 108 may fill the appropriately sized super block without padding the data which may postpone the early trigger of garbage collection or other relocation functions due to no or few free blocks on memory device 110. Postponing the execution of background relocation functions may in turn limit the use of a PE cycle on the physical blocks in the super block.

To mitigate issues associated with having critical resources like RAM, etc. needed for maintaining a super block per stream, controller 108 may align the stream size with a super block including a single physical block or multiple physical blocks. For instance, controller 108 may form a super block including multiple physical blocks to account for die parallelism for higher performance data. Controller 108 may also deallocate an entire super block (corresponding physical block(s)) when there is a release of a stream. Controller 108 may also relocate less amount of data at physical block level within the super block if there is a game update that results in de-fragment operation, thus reducing the write amplification factor.

In other applications including, for example, zone name space, controller 108 may form a super block wherein the super block size may be the same as a physical block size where storage device 104 may be used for endurance and/or performance. Controller 108 may thus optimize use of physical blocks by forming super blocks that may correspond to the size of the data being stored and other data characteristics including the usage mode (for example, performance data or storage data). In optimizing the size of the super block to correspond with the data being stored, controller 108 may reduce the write amplification factor on storage device 104. Besides the write amplification factor advantage, in an MEND environment, flexibly sized super blocks may help to improve the overall migration process and release underlying storage in rapid manner. Flexibly sized super blocks may also mitigate other potential challenges posed by increasing the super blocks size to correspond with increased underlying physical block size across NAND technologies. Flexibly sized super blocks may also allow controller 108 to efficiently utilize all available “good” blocks on memory device 110.

Storage device 104 may perform these processes based on a processor, for example, controller 108 executing software instructions stored by a non-transitory computer-readable medium, such as storage component 110. As used herein, the term “computer-readable medium” refers to a non-transitory memory device. Software instructions may be read into storage component 110 from another computer-readable medium or from another device. When executed, software instructions stored in storage component 110 may cause controller 108 to perform one or more processes described herein. Additionally, or alternatively, hardware circuitry may be used in place of or in combination with software instructions to perform one or more processes described herein. Thus, implementations described herein are not limited to any specific combination of hardware circuitry and software. System 100 may include additional components (not shown in this figure for the sake of simplicity). FIG. 1 is provided as an example. Other examples may differ from what is described in FIG. 1.

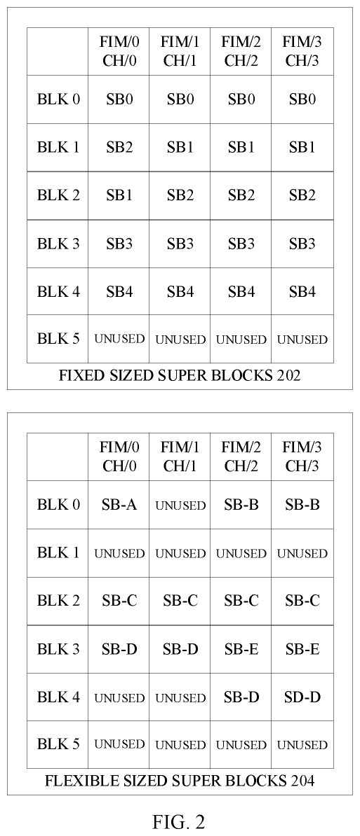

FIG. 2 is a block diagram showing fixed sized super blocks and flexible sized super blocks formed in accordance with some implementations. Examples of current implementations of fixed sized super blocks as shown in block 202 include super block 0 (SB0), super block 1 (SB1), super block 2 (SB2), super block 3 (SB3), and super block 4 (SB4). Each of SB0-SB4 includes a physical block from each flash interface module (FIM) and channel (CH). If another FIM/CH (for example, FIM4/CH4 (not shown) is added to memory device 110, each of SB0-SB4 will be modified to include a physical block from FIM4/CH4. As such, when another FIM/CH is added to memory device 110, the size of each of SB0-SB4 will increase.

Examples of flexible sized super blocks as shown in block 204 include super block A (SB-A), super block B (SB-B), super block C (SB-C), super block D (SB-D), and super block E (SB-E). SB-A includes physical block zero from FIM0/CH0 and SB-B includes physical block zero from FIM2/CH2 and FIM3/CH3. SB-C includes physical block two from each FIM/CH. SB-D also includes physical blocks from each FIM/CH, although SB-D includes physical blocks three from FIM0/CH0 and FIM1/CH1 and physical blocks four from FIM2/CH2 and FIM3/CH3. SB-E includes physical blocks three from FIM2/CH2 and FIM3/CH3. The flexible sized super blocks as shown in block 204 illustrate examples of super blocks formed by controller 108 according to the characteristics of the data that may be stored in each super block. For example, the size of SB-A is the same as that of block zero in FIM0/CH0. In another example, SB-B, SB-C, SB-D, and SB-E include multiple physical blocks and account for die parallelism for higher performance data. FIG. 2 is provided as an example. Other examples may differ from what is described in FIG. 2.

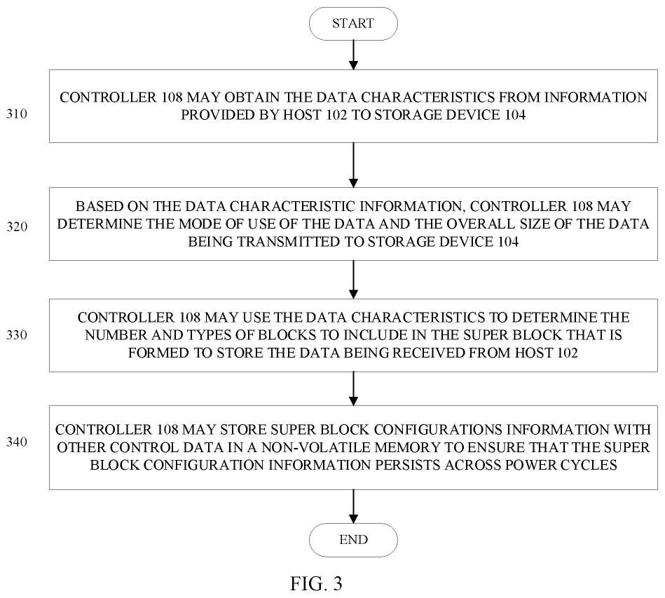

FIG. 3 is an example flow diagram for forming varying sized super block based on data characteristics information received from a host in accordance with some implementations. At 310, controller 108 may obtain the data characteristics from information provided by host 102 to storage device 104. At 320, based on the data characteristic information, controller 108 may determine the mode of use of the data and the overall size of the data being transmitted to storage device 104. At 330, controller 108 may use the data characteristics to determine the number and types of blocks to include in the super block that is formed to store the data being received from host 102. At 340, controller 108 may store super block configurations information with other control data in a non-volatile memory to ensure that the super block configuration information persists across power cycles. FIG. 3 is provided as an example. Other examples may differ from what is described in FIG. 3.

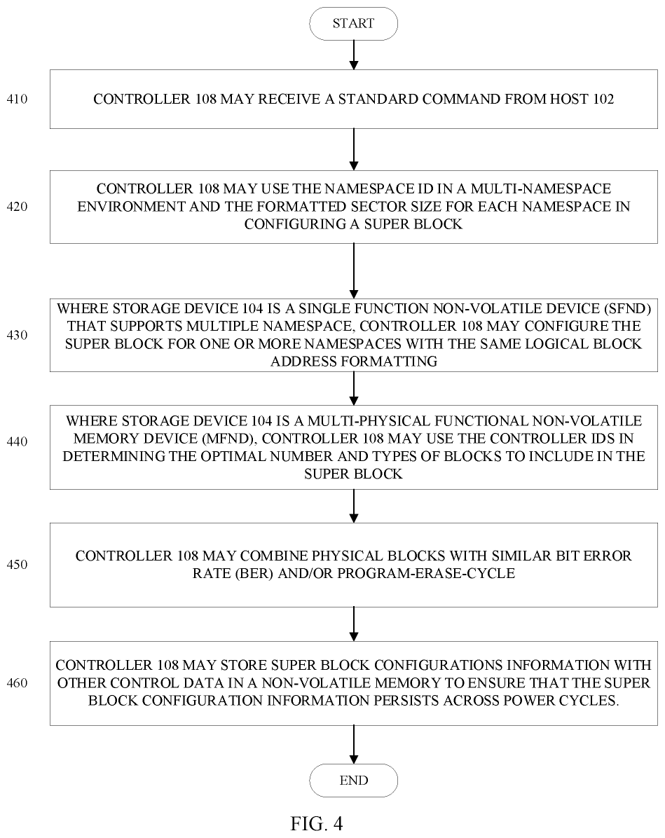

FIG. 4 is an example flow diagram for forming varying sized super block based on data characteristics information determined by the controller in accordance with some implementations. At 410, controller 108 may receive a standard command from host 102. At 420, controller 108 may use the namespace ID in a multi-namespace environment and the formatted sector size for each namespace in configuring a super block. At 430, where storage device 104 is a single function non-volatile device (SFND) that supports multiple namespace, controller 108 may configure the super block for one or more namespaces with the same logical block address formatting. At 440, where storage device 104 is a multi-physical functional non-volatile memory device (MFND), controller 108 may use the controller IDs in determining the optimal number and types of blocks to include in the super block.

At 450, controller 108 may combine physical blocks with similar bit error rate (BER) and/or program-erase-cycle. At 460, controller 108 may store super block configurations information with other control data in a non-volatile memory to ensure that the super block configuration information persists across power cycles. FIG. 4 is provided as an example. Other examples may differ from what is described in FIG. 4.

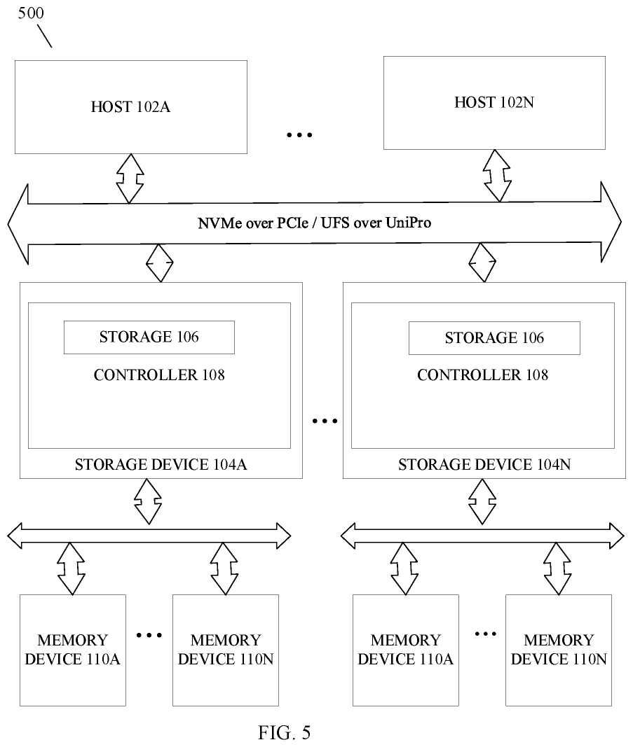

FIG. 5 is a diagram of an example environment in which systems and/or methods described herein are implemented. As shown in FIG. 5, Environment 500 may include hosts 102-102n (referred to herein as host(s) 102), and storage devices 104a-104n (referred to herein as storage device(s) 104).

Storage device 104 may include a controller 108 to manage the resources on storage device 104. Controller 108 may form super blocks based on data characteristics, wherein the super blocks may have various sizes. Hosts 102 and storage devices 104 may communicate via NVMe over peripheral component interconnect express (PCI Express or PCIe) standard, the Universal Flash Storage (UFS) over Unipro, or the like.

Devices of Environment 500 may interconnect via wired connections, wireless connections, or a combination of wired and wireless connections. For example, the network of FIG. 5 may include a cellular network (e.g., a long-term evolution (LTE) network, a code division multiple access (CDMA) network, a 3G network, a 4G network, a 4G network, another type of next-generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of Environment 500 may perform one or more functions described as being performed by another set of devices of Environment 500.

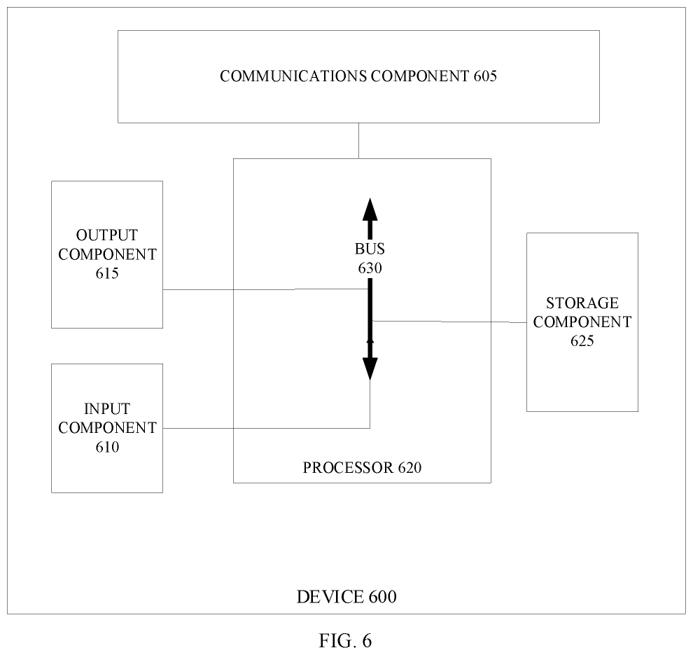

FIG. 6 is a diagram of example components of one or more devices of FIG. 1. In some implementations, host 102 may include one or more devices 600 and/or one or more components of device 600. Device 600 may include, for example, a communications component 605, an input component 610, an output component 615, a processor 620, a storage component 625, and a bus 630. Bus 630 may include components that enable communication among multiple components of device 600, wherein components of device 600 may be coupled to be in communication with other components of device 600 via bus 630.

Input component 610 may include components that permit device 600 to receive information via user input (e.g., keypad, a keyboard, a mouse, a pointing device, a microphone, and/or a display screen), and/or components that permit device 600 to determine the location or other sensor information (e.g., an accelerometer, a gyroscope, an actuator, another type of positional or environmental sensor). Output component 615 may include components that provide output information from device 600 (e.g., a speaker, display screen, and/or the like). Input component 610 and output component 615 may also be coupled to be in communication with processor 620.

Processor 620 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 620 may include one or more processors capable of being programmed to perform a function. Processor 620 may be implemented in hardware, firmware, and/or a combination of hardware and software.

Storage component 625 may include one or more memory devices, such as random-access memory (RAM) 106, read-only memory (ROM), and/or another type of dynamic or static storage device (e.g., a flash memory, a magnetic memory, and/or optical memory) that stores information and/or instructions for use by processor 620. A memory device may include memory space within a single physical storage device or memory space spread across multiple physical storage devices. Storage component 625 may also store information and/or software related to the operation and use of device 600. For example, storage component 625 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, and/or another type of non-transitory computer-readable medium, along with a corresponding drive.

Communications component 605 may include a transceiver-like component that enables device 600 to communicate with other devices, such as via a wired connection, a wireless connection, or a combination of wired and wireless connections. The communications component 605 may permit device 600 to receive information from another device and/or provide information to another device. For example, communications component 605 may include an Ethernet interface, an optical interface, a coaxial interface, an infrared interface, a radio frequency (RF) interface, a universal serial bus (USB) interface, a Wi-Fi interface, and/or a cellular network interface that may be configurable to communicate with network components, and other user equipment within its communication range. Communications component 605 may also include one or more broadband and/or narrowband transceivers and/or other similar types of wireless transceiver configurable to communicate via a wireless network for infrastructure communications. Communications component 605 may also include one or more local area network or personal area network transceivers, such as a Wi-Fi transceiver or a Bluetooth transceiver.

Device 600 may perform one or more processes described herein. For example, device 600 may perform these processes based on processor 620 executing software instructions stored by a non-transitory computer-readable medium, such as storage component 625. As used herein, the term “computer-readable medium” refers to a non-transitory memory device. Software instructions may be read into storage component 625 from another computer-readable medium or from another device via communications component 605. When executed, software instructions stored in storage component 625 may cause processor 620 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 6 are provided as an example. In practice, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more.” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, or “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

We claim:

1. A storage device to reduce increases to a program erase cycle count associated with a physical block by forming super blocks of varying sizes, the storage device comprises:
a memory device including at least one die divided into physical blocks; and
a controller to identify characteristics of data to be stored on the memory device, select physical blocks from the at least one die to be used in forming a super block, optimize a super block configuration based on data characteristics, align a super block size with the data characteristics, and form the super block with at least one physical block,
wherein by aligning the super block size with the data characteristics, data relocation on the super block is reduced and increases to the program erase cycle count associated with a physical block is reduced.

2. The storage device of claim 1, wherein the controller receives the data characteristics from a host through a standard protocol.

3. The storage device of claim 2, wherein the data characteristics include at least one of a mode of use for the data including a performance intensive mode and a data storage mode and an overall size of the data.

4. The storage device of claim 1, wherein the controller determines the data characteristics from a standard host command.

5. The storage device of claim 4, wherein the controller uses a namespace identifier in a multi-namespace environment and a formatted sector size for a namespace to obtain the data characteristics.

6. The storage device of claim 4, wherein the controller configures the super block for at least one namespace with a same logical block address formatting.

7. The storage device of claim 4, wherein the controller configures the super block with a controller identifier, wherein the controller uses the controller identifier in determining an optimal number and types of physical blocks to include in the super block.

8. The storage device of claim 1, wherein the controller makes interdependent decisions based on dynamic configuration of the super block.

9. The storage device of claim 1, wherein in configuring the super block, the controller combines physical blocks with at least one of a similar bit error rate and program-erase-cycle.

10. The storage device of claim 1, wherein the controller stores super block configuration information in a non-volatile memory.

11. The storage device of claim 1, wherein the controller forms the super block to include multiple physical blocks and to account for die parallelism for higher performance data.

12. The storage device of claim 1, wherein the super block size is the same as a physical block size.

13. A method for reducing increases to a program erase cycle count associated with a physical block by forming super blocks of varying size in a storage device, the storage device includes a controller to execute the method comprising:
identifying characteristics of data to be stored on a memory device;
selecting physical blocks from at least one die on the memory device to be used in forming a super block;
optimizing a super block configuration based on data characteristics; and
aligning a super block size with the data characteristics; and
forming the super block with at least one physical block,
wherein by aligning the super block size with the data characteristics, data relocation on the super block is reduced and increases to the program erase cycle count associated with a physical block is reduced.

14. The method of claim 13, further comprising receiving the data characteristics from a host through a standard protocol, wherein the data characteristics include at least one of a mode of use for the data including a performance intensive mode and a data storage mode and an overall size of the data.

15. The method of claim 13, further comprising determining the data characteristics from a standard host command.

16. The method of claim 15, further comprising using a namespace identifier in a multi-namespace environment and a formatted sector size for a namespace to obtain the data characteristics and configuring the super block for at least one namespace with a same logical block address formatting.

17. The method of claim 15, further comprising configuring the super block with a controller identifier and using the controller identifier in determining an optimal number and types of physical blocks to include in the super block.

18. The method of claim 13, wherein forming the super block comprises combining physical blocks with at least one of a similar bit error rate and program-erase-cycle.

19. The method of claim 13, further comprising storing super block configuration information in a non-volatile memory.

20. A method for reducing increases to a program erase cycle count associated with a physical block by forming super blocks of varying size in a storage device, the storage device includes a controller to execute the method comprising:
identifying characteristics of data to be stored on a memory device;
selecting physical blocks from the at least one die on the memory device to be used in forming a super block;
optimizing a super block configuration based on data characteristics; and
aligning a super block size with the data characteristics; and
forming the super block with multiple physical blocks to account for die parallelism for higher performance data,
wherein by aligning the super block size with the data characteristics, data relocation on the super block is reduced and increases to the program erase cycle count associated with a physical block is reduced.
